(19) United States
(12) Patent Application Publication
(10) Pub. No.: US 2021/0325908 A1
(43) Pub. Date: Oct. 21, 2021

(54) SELECTION DEVICE, SELECTION METHOD, AND SELECTION PROGRAM

(71) Applicant: NEC Corporation, Minato-ku, Tokyo (JP)

(72) Inventor: Toshiaki YAMASHITA, Tokyo (JP)

(73) Assignee: NEC Corporation, Minato-ku, Tokyo (JP)

(21) Appl. No.: 17/269,126

(22) PCT Filed: Aug. 20, 2019
(86) PCT No.: PCT/JP2019/032339

§ 371 Date: Feb. 17, 2021

(30) Foreign Application Priority Data
Aug. 22, 2018 (JP) 2018-155678

(51) Int. Cl. G05D 1/10

(52) U.S. Cl. CPC G05D 1/106; G06K 9/0063

(57) ABSTRACT

In order to enable both positioning control and movement control of a moving body that have been adapted to the movement state of the moving body, a selection device comprises: a movement mode designation unit that designates a movement mode for a movement performed by the moving body on the basis of surroundings state information expressing the state of the surroundings of the moving body, and movement state information expressing the movement state of the moving body; and a selection unit that uses the movement mode to select a control mode from either a first control mode for performing a first control, which is a control of the position and orientation of the moving body, or a second control mode for performing a second control, which is a control of the velocity and angular velocity of the moving body.

### TECHNICAL FIELD

The present invention relates to movement control of a moving body.

### BACKGROUND ART

A multicopter (drone) that goes up and flies by a multispindle rotary-wing rotor having a plurality of rotary wings is easy to handle, and therefore, is under consideration for application to observation and monitoring of a thing, and further to inspection work to which an infrastructure construction or the like is subjected.

For example, a multicopter disclosed in PTL 1 includes a large number of rotary-wing rotors that are attached to a cylindrical body molded with a composite material made of carbon fiber, thermosetting synthetic resin, and a metal, in such a way as to be equally distributed over the whole body.

In an unmanned craft system disclosed in PTL 2, an unmanned craft is connected to mooring equipment via a mooring rope. The unmanned craft system enables maintenance control over tension of the mooring rope in a predetermined condition, depending on variation in an environmental condition during occurrence of a strong wind or the like, by cooperation of the unmanned craft in the sky and the mooring equipment on the ground.

NPLs 1 to 3 disclose a flying robot system and the like for performing infrastructure inspection.

### CITATION LIST

### Patent Literature

[PTL 1] Japanese Patent No. 6156669

[PTL 2] Japanese Unexamined Patent Application Publication No. 2017-217942

### Non Patent Literature

[NPL 1] Toshiaki Yamashita et al., Inspection System for Infrastructure Using Flying Robot, Proceedings of the 53rd Aircraft Symposium, 2G06.

[NPL 2] Toshiaki Yamashita et al., Performance Evaluation of Inspection System for Infrastructure Using Flying Robot, Proceedings of the 54th Aircraft Symposium, 2L09.

[NPL 3] Michitaro Shozawa et al., Development of the Safe Inspection System for Infrastructure Using Flying Robot, Proceedings of the 55th Aircraft Symposium, 1F10.

### SUMMARY OF INVENTION

### Technical Problem

A flying robot for infrastructure inspection disclosed in each of NPLs 1 to 3 is intended to perform a hammering inspection for a bridge pier or the like. During the hammering inspection, the flying robot brings a tip of a hammering test machine into contact with an inspection subject such as a wall surface of a bridge pier or the like. The flying robot generates a sound by driving a hammer mounted on the hammering test machine at a certain frequency, and continuously beating the inspection subject with the hammer. Further, the flying robot performs a hammering test for a predetermined range of the inspection subject by moving the tip at a predetermined velocity. Thus, it is important that both of the following two points can be achieved: position accuracy when the tip portion is fixed at a surface position of a designated wall surface or the like; and a velocity at which the tip portion moves being as set.

However, a position and a moving velocity of the tip portion depend on a position and an orientation of a flying robot body as well as velocity and an angular velocity thereof. As a result, control accuracy of the flying robot body itself deteriorates due to an influence of disturbance on the tip portion contacting the wall surface or the like.

Thus, when such control as to be performed by a general drone is performed by the robot for infrastructure inspection disclosed in each of NPLs 1 to 3, it is difficult, without modification, to achieve both positioning performance of the tip portion and moving velocity accuracy.

An object of the present invention is to provide a selection device and the like enabling both positioning control and movement control of a moving body that are more suitable to a movement state of the moving body and a state of a surrounding.

### Solution to Problem

A selection device according to the present invention includes: a movement mode designation unit that designates, from surrounding state information representing a state of a surrounding of a moving body performing movement, and movement state information representing a movement state of the moving body, a movement mode related to the movement; and a selection unit that performs, depending on the movement mode, control mode selection being selection of one of a first control mode for performing first control being control of a position and an orientation of the moving body, and a second control mode for performing second control being control of a velocity and an angular velocity of the moving body.

### ADVANTAGEOUS EFFECTS OF INVENTION

A selection device and the like according to the present invention enable both positioning control and movement control of a moving body that are more suitable to a movement state of the moving body and a state of a surrounding.

### BRIEF DESCRIPTION OF DRAWINGS

FIG. 1 is a block diagram representing a configuration example of a flying body according to the present example embodiment.

FIG. 2 is a conceptual diagram representing a configuration example of a movement control unit.

FIG. 3 is a conceptual diagram representing an allocation example of position control performance information.

FIG. 4 is a conceptual diagram representing an allocation example of orientation control performance information.

FIG. 5 is a conceptual diagram representing an allocation example of velocity control performance information.

FIG. 6 is a conceptual diagram representing an allocation example of angular velocity performance information.

FIG. 7 is a block diagram representing a minimum configuration of a selection device according to an example embodiment.

### EXAMPLE EMBODIMENT

Depending on a movement state of a flying body and a state of a surrounding, the movement can be classified into a case of controlling a position and an orientation, and a case of controlling a velocity and an angular velocity.

A flying body according to the present example embodiment switches a control mode related to a flight between the first control mode for performing control of a position and an orientation of the flying body, and the second control mode for controlling a velocity and an angular velocity of the flying body. The flying body performs the switch by a state of a surrounding of the flying body such as a wind velocity and a wind direction detected by a sensor, and a movement state of the flying body. Thus, the flying body enables flight control being more suitable to a movement state of the moving body and a state of a surrounding.

### Configuration and Operation

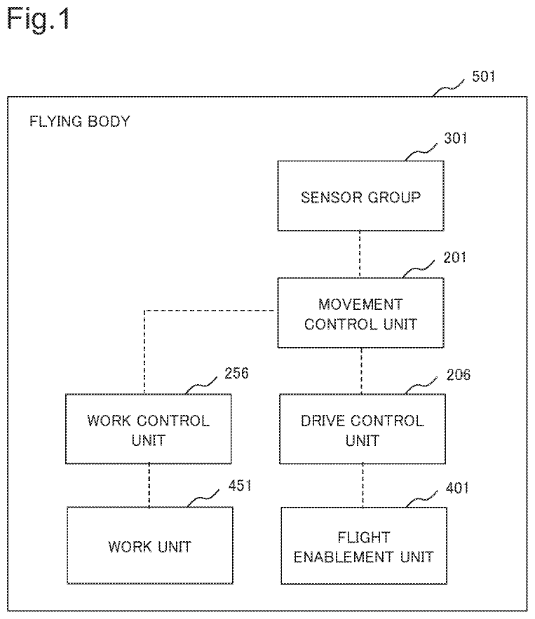

FIG. 1 is a block diagram representing a configuration of a flying body 501 being an example of a flying body according to the present example embodiment.

The flying body 501 is, for example, a multicopter, a drone, or a flying robot. More specifically, the flying body 501 is, for example, a multicopter that flies to a position of a test subject and executes a predetermined test regarding the test subject. The test subject is, for example, a predetermined portion of a bridge pier. The test is, for example, a hammering test that performs an analysis or the like of a sound generated by beating the portion with a predetermined portion of the flying body 501. Such a multicopter that performs a hammering test is disclosed in, for example, NPLs 1 to 3.

The flying body 501 includes a movement control unit 201, a drive control unit 206, a work control unit 256, a sensor group 301, a flight enablement unit 401, and a work unit 451.

The sensor group 301 is a sensor group constituted of a sensor placed in each portion of the flying body 501. The sensors constituting the sensor group 301 are, for example, a wind direction sensor, a wind velocity sensor, an air pressure sensor, an altitude sensor, an image sensor (camera), a laser distance sensor, a contact sensor, and the like. Each of the sensors sequentially sends detected sensor information to the movement control unit 201. The sensor information is surrounding state information representing a state of a surrounding of the flying body 501.

The movement control unit 201 selects a control unit to send control information related to a flight to the drive control unit 206, by the sensor information sent from the sensor group 301. The movement control unit 201 includes a plurality of the control units. The control units are separated into, for example, a unit for controlling a velocity and an angular velocity of the flying body 501, and a unit for controlling a position and an orientation of the flying body 501. The control units include a plurality of control units differing in control performance.

The drive control unit 206 performs control related to driving of the flight enablement unit 401, by the control unit selected by the movement control unit 201.

The flight enablement unit 401 executes a flying operation of the flying body 501 in accordance with drive control by the drive control unit 206.

The flight enablement unit 401 includes, for example, four or more propellers. In this case, the flight enablement unit 401 performs floating, descending, movement, and an orientation change of the flying body 501 by changing the number of revolutions of each propeller in accordance with the drive control.

The work control unit 256 causes the work unit 451 to execute a predetermined work, when being sent, by the movement control unit 201, flight mode information that a flight mode is a work mode. The work is, for example, the above-described hammering test of a bridge pier. Herein, the hammering test tests a state of sound quality or the like of a generated sound by beating a subject with a predetermined part of the work unit 451.

The flying body 501 brings a tip of a hammering test machine into contact with an inspection subject such as a wall surface of a bridge pier or the like during the hammering inspection, for example, in a way similar to the flying robot described in the section of Technical Problem. The flying body 501 generates a sound by driving a hammer mounted on the hammering test machine at a certain frequency, and continuously beating the inspection subject with the hammer. Further, the flying robot performs a hammering inspection for a predetermined range of the inspection subject by moving the tip at a predetermined velocity.

The work unit 451 executes the work in accordance with an instruction from the work control unit 256.

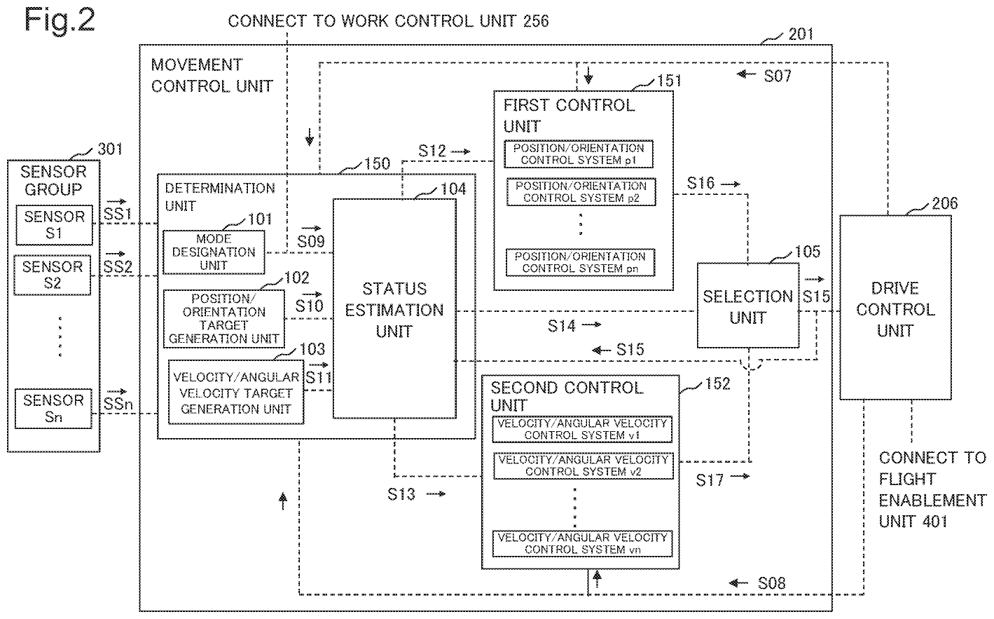

FIG. 2 is a conceptual diagram representing a configuration example of the movement control unit 201 represented in FIG. 1.

The movement control unit 201 represented in FIG. 2 includes a determination unit 150, a first control unit 151, a second control unit 152, and a selection unit 105.

The determination unit 150 includes a mode designation unit 101, a position/orientation target generation unit 102, a velocity/angular velocity target generation unit 103, and a status estimation unit 104.

The first control unit 151 is capable of selecting any of position/orientation control systems p1 to pn. Each of the position/orientation control systems p1 to pn (each position/orientation control system) is a control system that performs only control of a position and an orientation. Each of the position/orientation control systems differs in control performance from another of the position/orientation control systems. The control performance is performance associated with control accuracy being representable by a combination of a control error and a response velocity as described later. The first control unit 151 has, for example, a structure of known variable structure control, and thereby, the position/orientation control systems p1 to pn differing in control performance are selected.

The second control unit 152 is capable of selecting any of velocity/angular velocity control systems v1 to vn. Each of the velocity/angular velocity control systems v1 to vn (each velocity/angular velocity control system) is a control system that performs only control of a position and an orientation. Each of the velocity/angular velocity control systems differs in control performance from another of the velocity/angular velocity control systems. The control performance is performance associated with control accuracy being representable by a combination of a control error and a response velocity as described later. The first control unit 151 has, for example, a structure of known variable structure control, and thereby, the velocity/angular velocity control systems v1 to vn differing in control performance are selected.

The sensor group 301 includes sensors S1 to Sn.

Each piece of above-described sensor information SS1 to SSn is sent to each of the mode designation unit 101, the position/orientation target generation unit 102, the velocity/angular velocity target generation unit 103, and the status estimation unit 104 from each of the sensors S1 to Sn (each sensor) of the sensor group 301.

Position/orientation estimation information S07 and velocity/angular velocity estimation information S08 are sent to each of the mode designation unit 101, the position/orientation target generation unit 102, and the velocity/angular velocity target generation unit 103 from the drive control unit 206. Herein, the position/orientation estimation information S07 is estimation information generated by the drive control unit 206 and regarding a position and an orientation of the flying body 501. The velocity/angular velocity estimation information S08 is estimation information generated by the drive control unit 206 and regarding a velocity and an angular velocity of the flying body 501.

The mode designation unit 101 derives movement state information representing a movement state of the flying body 501 from each piece of sensor information sent from each sensor, and the position/orientation estimation information or the velocity/angular velocity estimation information sent from the drive control unit 206. The mode designation unit 101 may use, as the movement state information, position estimation information included in the position/orientation estimation information and representing an estimated value of a position of the flying body 501. Alternatively, the mode designation unit 101 may use, for the movement state information, a size of a predetermined thing in an image captured by the image sensor being one of the sensors included in the sensor group 301, as described in a later-described specific example. Alternatively, the mode designation unit 101 may use, for the state information, a combination of position estimation information and sensor information.

The mode designation unit 101 generates, from the flight state information, flight mode information S09 representing a flight mode of the flying body 501.

The flight mode is, for example, a takeoff mode, a landing mode, an ascending/descending mode, a level flight mode, an approach mode, a contact mode, a work mode, or the like.

Herein, the takeoff mode is, for example, a flight mode that causes the flying body 501 to float from a start point. The takeoff mode is, for example, a flight mode that causes the flying body 501 to land on a landing point.

The ascending/descending mode is, for example, a flight mode that causes the flying body 501 to ascend or descend to a predetermined height immediately above the point of the flying body 501. The level flight mode is a flight mode that causes the flying body 501 to fly level to a predetermined point while maintaining an altitude. The approach mode is a flight mode that causes the flying body 501 to approach at a predetermined distance from a predetermined position of a subject. The contact mode is a flight mode that causes the flying body 501 to contact a predetermined position of a subject. The work mode is a flight mode that causes the flying body 501 to perform a predetermined work. The work is, for example, the above-described hammering test of a subject.

The mode designation unit 101 sends the generated flight mode information S09 to the status estimation unit 104 and the work control unit 256 represented in FIG. 1.

The position/orientation target generation unit 102 generates position/orientation target information S10 representing targets of a position and an orientation of the flying body 501, from each piece of sensor information sent from each sensor, and the position/orientation estimation information sent from the drive control unit 206. The position/orientation target generation unit 102 sends the generated position/orientation target information S10 to the status estimation unit 104.

The velocity/angular velocity target generation unit 103 generates velocity/angular velocity target information S11 representing targets of a velocity and an angular velocity of the flying body 501, from each piece of sensor information sent from each sensor, and the position/orientation estimation information S07 and the velocity/angular velocity estimation information S08 sent from the drive control unit 206. The velocity/angular velocity target generation unit 103 sends the generated velocity/angular velocity target information S11 to the status estimation unit 104.

The status estimation unit 104 implements, as control mode selection, selection of which of position/orientation control and velocity/angular velocity control is appropriate, from the flight mode information S09, the position/orientation target information S10, the velocity/angular velocity target information S11, and control information S15 output last by the selection unit 105.

The position/orientation control is control relating to only a position and an orientation of the flying body 501.

On the other hand, the velocity/angular velocity control is control relating to only a velocity and an angular velocity of the flying body 501.

As a result of performing the velocity/angular velocity control, a case is assumable where the flying body 501 mistakes a position and an orientation approximates a status where a flight is difficult to continue. In such a case, the status estimation unit 104 detects an abnormality by sensor information sent from the sensor group 301. The status estimation unit 104 immediately switches a control mode to a position/orientation control mode. Thus, the status estimation unit 104 avoids a danger of a crash due to a large deviation in a position of the flying body 501 or loss of a proper orientation.

For example, it is assumed that sensor information is image information captured by a camera being a sensor included in the sensor group 301. In this case, when a shape of a thing that should be included in an image represented by the image information is not detected, the status estimation unit 104 detects a great deviation in position or orientation. The status estimation unit 104 switches a control mode from the velocity/angular velocity control mode to the position/orientation control mode, and controls the flying body 501 in such a way that the thing is included in the image.

Hereinafter, the flight mode information S09, the position/orientation target information S10, the velocity/angular velocity target information S11, and control information S15 output last by the selection unit 105 are defined as a “first information group”.

The status estimation unit 104 previously stores, for example, first association information being information associating a combination of the first information group with a selection result related to the control mode selection. The status estimation unit 104 performs the control mode selection from a combination of the first information group at a timing of performing selection, and the first association information. The status estimation unit 104 sends selection information representing the selection result to the selection unit 105.

The status estimation unit 104 may perform the control mode selection only by the flight mode information S09.

The status estimation unit 104 may perform the control mode selection only by position estimation information included in the position/orientation estimation information S07.

Alternatively, the status estimation unit 104 may perform the control mode selection by the flight mode information S09, and position divergence information representing a degree of divergence between position estimation information included in the position/orientation information S07 and position target information included in the position/orientation target information at the time point.

When the position/orientation control is selected by the control mode selection, the status estimation unit 104 specifies position/orientation control performance information representing position/orientation control performance being required performance (accuracy) of position/orientation control. The status estimation unit 104 performs the specification from the first information group. The status estimation unit 104 previously holds, for example, second association information being information associating a combination of the first information group with position/orientation performance information. The status estimation unit 104 performs the specification of the position/orientation performance information from a combination of the first information group at a timing of performing selection, and the second association information.

The status estimation unit 104 performs, by the specified position/orientation control performance information, selection (position/orientation control system selection) of a system that is caused to actually perform position/orientation control, from among the position/orientation control systems of the first control unit 151. In this instance, when a plurality of combination of position/orientation control systems are capable of performing position/orientation control, the status estimation unit 104 may select a plurality of position/orientation control systems.

The status estimation unit 104 previously holds, for example, third association information being information representing association of each piece of position/orientation control performance information with a position/orientation control system assumed to achieve position/orientation control performance represented by the position/orientation performance information. The status estimation unit 104 performs the position/orientation control system selection related to a position/orientation control system, from the specified position/orientation control performance information and the third association information.

When performing the position/orientation control system selection, the status estimation unit 104 sends first selection information S12 including information representing the selection result to the first control unit 151. The first selection information S12 includes the position/orientation target information S10 sent from the position/orientation target generation unit 102.

On the other hand, when selecting the velocity/angular velocity control by the control mode selection, the status estimation unit 104 specifies velocity/angular velocity control performance information representing required performance (accuracy) regarding velocity/angular velocity control. The status estimation unit 104 performs the specification from the first information group. The status estimation unit 104 previously holds, for example, fourth association information being information associating a combination of the first information group with the velocity/angular velocity control performance information. The status estimation unit 104 performs the specification of the velocity/angular velocity control performance information from a combination of the first information group at a timing of performing selection, and the fourth association information.

The status estimation unit 104 performs, from the velocity/angular velocity control performance information, selection (velocity/angular velocity control system selection) of a system that is caused to perform velocity/angular velocity control, from among the velocity/angular velocity control systems of the second control unit 152. However, in this instance, when a combination of a plurality of velocity/angular velocity control systems are capable of performing velocity/angular velocity control, the status estimation unit 104 may select a plurality of velocity/angular velocity control systems.

The status estimation unit 104 previously holds, for example, fifth association information being information representing association of each piece of velocity/angular velocity control performance information with a velocity/angular velocity control system assumed to achieve control performance represented by the velocity/angular velocity control performance information. The status estimation unit 104 performs the velocity/angular velocity control system selection from the derived velocity/angular velocity control performance information and the fifth association information.

When performing the velocity/angular velocity control system selection, the status estimation unit 104 sends second selection information S13 representing the selection result to the second control unit 152. The second selection information S13 includes velocity/angular velocity target information sent from the velocity/angular velocity target generation unit 103.

The first control unit 151 includes a plurality of position/orientation control systems differing in position/orientation control performance. Each position/orientation control system, for example, differs in control type, and thus, differs in the first accuracy. Since a control type that achieves higher-performance control is well known, description is omitted herein.

When being sent the first selection information from the status estimation unit 104, the first control unit 151 selects a position/orientation control system represented by the first selection information. The first control unit 151 performs, by the selected position/orientation control system, subsequent position/orientation control in the first control unit 151. The selected position/orientation control system generates position/orientation control information S16 for controlling the drive control unit 206, by the position/orientation target information S10 included in the first selection information S12, and the position/orientation estimation information sent from the drive control unit 206, and sends the position/orientation control information S16 to the selection unit 105.

The second control unit 152 includes a plurality of velocity/angular velocity control systems differing in velocity/angular velocity control performance. Each velocity/angular velocity control system, for example, differs in control type, and thus, differs in the velocity/angular velocity control performance.

When being sent the second selection information from the status estimation unit 104, the second control unit 152 selects a velocity/angular velocity control system represented by the second selection information. The second control unit 152 performs subsequent velocity/angular velocity control in the second control unit 152 by the selected velocity/angular velocity control system. The selected velocity/angular velocity control system generates velocity/angular velocity control information S17 for controlling the drive control unit 206, by the velocity/angular velocity target information included in the second selection information S13, and the velocity/angular velocity estimation information S08 sent from the drive control unit 206, and sends the velocity/angular velocity control information S17 to the selection unit 105.

The selection unit 105 selects one of the position/orientation control information S16 and the velocity/angular velocity control information S17 by control mode determination information S14. The selection unit 105 sends, to the drive control unit 206 and the status estimation unit 104, the control information S15 including selected one of the position/orientation control information S16 and the velocity/angular velocity control information S17.

The drive control unit 206 drives the flight enablement unit 401 by the control information S15 sent from the selection unit 105.

The drive control unit 206 includes, for example, an acceleration sensor being capable of detecting accelerations in directions of three axes orthogonal to one another. The drive control unit 206 estimates a position, an orientation, a velocity, and an angular velocity of the flying body 501, from the detected accelerations in the directions of three axes. Since a method of estimating a position, an orientation, a velocity, and an angular velocity of the flying body 501 from accelerations in directions of three axes is well known, description is omitted.

The drive control unit 206 sends the position/orientation estimation information S07 representing the estimated position and orientation to the determination unit 150 and the first control unit 151. The drive control unit 206 sends the velocity/angular velocity estimation information S08 representing estimated values of a velocity and an angular velocity of the flying body 501 to the determination unit 150 and the second control unit 152.

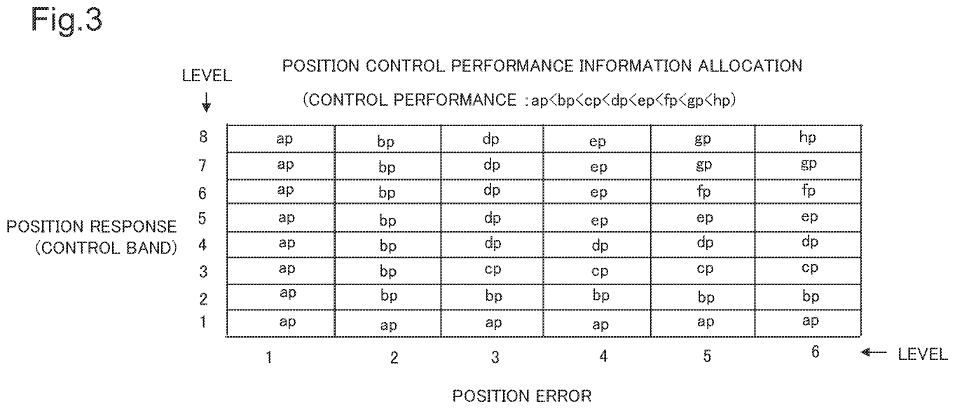

FIG. 3 is a conceptual diagram representing an allocation example of position control performance information used when the status estimation unit 104 selects a position/orientation control system included in the first control unit 151. Each of ap to hp represented in FIG. 3 is an identifier (ID) of position control information. Control performance represented by each position control performance information ID is allocated in such a way as to be the lowest at ap, and become higher as a left alphabet in an ID becomes closer to h.

Each piece of position control information is allocated regarding a combination of position response and a position error. Herein, a position error is, for example, information representing a maximum value of an error in position resulting from position control. Position response is, for example, information representing a maximum value of a time required until a position after control is reached. It is known that position response depends on a bandwidth of a control band.

In relation to a position error, position control performance information is divided into 6 levels. As a numerical value representing a level of the position control performance information is greater, control with fewer position errors can be performed.

In relation to position response, position control performance information is divided into 8 levels. As a numerical value representing a level of the position control performance information is greater, control with good position response can be performed.

In the example represented in FIG. 3, a position control performance information ID of ap in which control performance relating to a position is at the lowest level is allocated to a case where one of position response and a position error is at level 1. Position control information is allocated in such a way that a level of control performance becomes higher along with a shift to an upper right region of FIG. 3. A position control performance information ID of hp representing that control performance relating to a position is the highest is allocated to a case where both a position error and position response are at the highest levels.

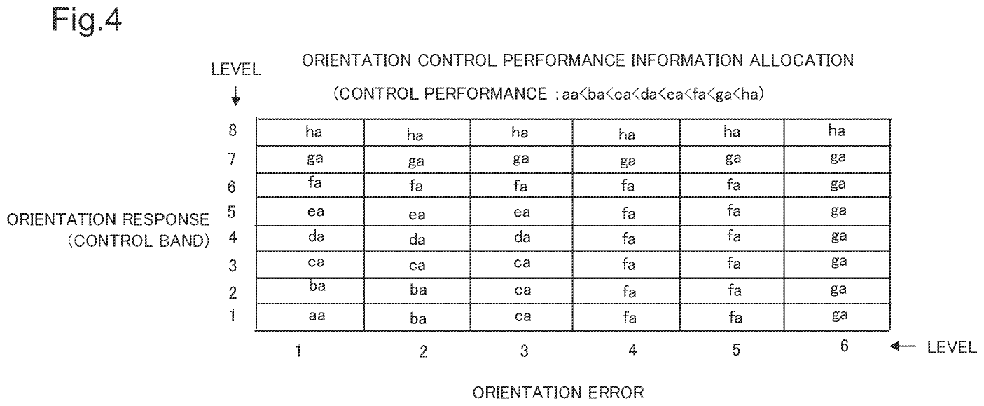

FIG. 4 is a conceptual diagram representing an allocation example of orientation control performance information used when the status estimation unit 104 selects a position/orientation control system included in the first control unit 151. Each of aa to ha represented in FIG. 4 is an orientation control performance information ID representing orientation control information. It is assumed that control performance represented by each orientation control performance information ID is the lowest at aa, and becomes higher as a left alphabet in each ID becomes closer to h.

Each piece of orientation control information is allocated regarding a combination of orientation response and an orientation error. Herein, an orientation error is, for example, information representing a maximum value of an error in orientation resulting from orientation control. Orientation response is, for example, information representing a maximum value of a time required until an orientation after control is reached. It is known that orientation response depends on a bandwidth of a control band.

In relation to an orientation error, orientation control performance information is divided into 6 levels. As a numerical value representing a level of the orientation control performance information is greater, control with fewer orientation errors can be performed.

On the other hand, in relation to orientation response, orientation control performance information is divided into 8 levels. As a numerical value representing a level of the orientation control performance information is greater, control with good orientation response can be performed.

An orientation control performance information ID of aa representing that control performance relating to an orientation is at the lowest level is allocated to a case where both orientation response and an orientation error are at level 1.

Orientation control information is allocated in such a way that control performance becomes higher toward an upper right region of FIG. 4.

An orientation control performance information ID of ha representing that control performance relating to an orientation is the highest is allocated to a case where orientation response is at the highest level.

The status estimation unit 104 represented in FIG. 2 performs selection of a position/orientation control system of the first control unit 151 as below by use of position control performance information allocation represented in FIG. 3 and orientation control performance information allocation represented in FIG. 4.

The status estimation unit 104 first derives, from the above-described first information group, a position error, position response, an orientation error, and orientation response that are needed.

The status estimation unit 104 specifies, from the derived position error and position response, a position control performance information ID by the position control performance information allocation represented in FIG. 3.

The status estimation unit 104 also specifies, from the derived orientation error and orientation response, an orientation control performance information ID by the orientation control performance information allocation represented in FIG. 4.

The status estimation unit 104 previously holds, in a non-illustrated storage unit, sixth association information representing association of each position/orientation control system included in the first control unit 151 with a combination of a position control performance information ID and an orientation control performance information ID that are related to the position/orientation control system.

The status estimation unit 104 selects, with reference to the sixth association information, one position/orientation control system being higher in position control performance than the specified position control performance information ID and higher in orientation control performance than the specified orientation control performance information ID. When there are a plurality of position control information units satisfying the above-mentioned performance, the status estimation unit 104 may select, from among the position control information units, a unit that performs control with the least power consumption. A unit that performs control with the least power consumption may be a unit with the lowest performance in which position control performance is combined with orientation control performance.

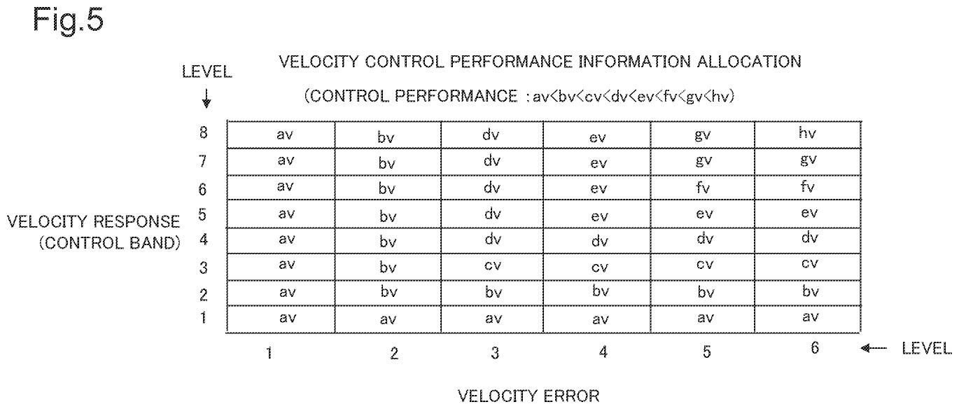

FIG. 5 is a conceptual diagram representing an allocation example of velocity control performance information used when the status estimation unit 104 selects a velocity/angular velocity control system included in the second control unit 152. Each of av to hv represented in FIG. 5 is a velocity control information ID. Control performance represented by each velocity control performance information ID is allocated in such a way as to be the lowest at av, and become higher as the velocity control performance information ID becomes closer to hv in an alphabetical order.

Each piece of velocity control information is allocated regarding a combination of velocity response and a velocity error. The velocity error is, for example, information representing a maximum value of an error in velocity resulting from velocity control. Velocity response is, for example, information representing a maximum value of a time required until a velocity after control is reached. It is known that velocity response depends on a bandwidth of a control band.

In relation to a velocity error, velocity control performance information is divided into 6 levels. As a numerical value representing a level of the velocity control performance information is greater, control with fewer velocity errors can be performed.

On the other hand, in relation to velocity response, velocity control performance information is divided into 8 levels. As a numerical value representing a level of the velocity control performance information is greater, control with good velocity response can be performed.

A velocity control performance information ID of av representing that control performance relating to a velocity is at the lowest level is allocated to a case where one of velocity response and a velocity error is at level 1.

Velocity control information is allocated with a level of control performance becoming higher toward an upper right region of FIG. 5.

A velocity control performance information ID of hv representing that control performance relating to a velocity is the highest is allocated to a case where both a velocity error and velocity response are at the highest level.

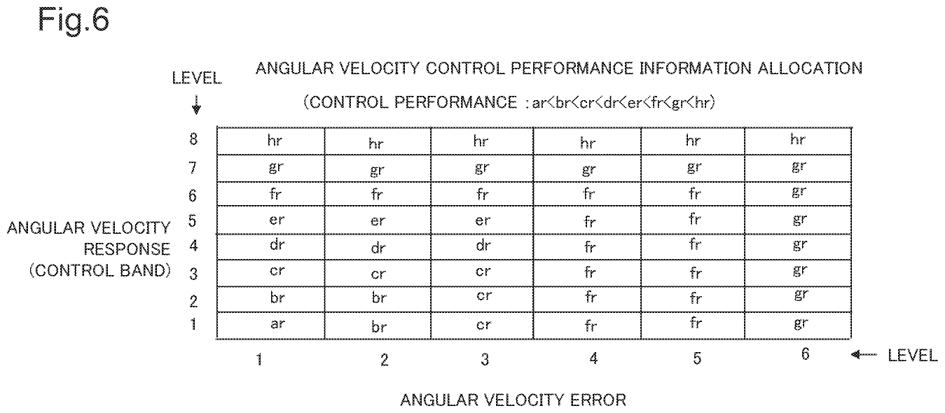

FIG. 6 is a conceptual diagram representing an allocation example of angular velocity performance information used when the status estimation unit 104 selects a velocity/angular velocity control system included in the second control unit 152. Each of ar to hr represented in FIG. 6 is an angular velocity control information ID. Control performance represented by each angular velocity control performance information ID is allocated in such a way as to be the lowest at ar, and become higher as the angular velocity control performance information ID becomes closer to hr in an alphabetical order.

Each piece of angular velocity control information is allocated regarding a combination of angular velocity response and an angular velocity error. An angular velocity error is, for example, information representing a maximum value of an error in angular velocity resulting from angular velocity control. Angular velocity response is, for example, information representing a maximum value of a time required until an angular velocity after control is reached. It is known that angular velocity response depends on a bandwidth of a control band.

In relation to an angular velocity error, angular velocity control performance information is divided into 6 levels. As a numerical value representing a level of the angular velocity control performance information is greater, control with fewer angular velocity errors can be performed.

In relation to angular velocity response, angular velocity control performance information is divided into 8 levels. As a numerical value representing a level of the angular velocity control performance information is greater, control with good angular velocity response can be performed.

An angular velocity control performance information ID of ar in which control performance relating to an angular velocity is at the lowest level is allocated to a case where both angular velocity response and an angular velocity error are at level 1.

Angular velocity control information is allocated with a level of control performance becoming higher toward an upper right region of FIG. 6.

An angular velocity control performance information ID of hr representing that control performance relating to an angular velocity is the highest is allocated to a case where angular velocity response is at the highest level.

The status estimation unit 104 represented in FIG. 2 performs selection of a velocity/angular velocity control system of the second control unit 152 as below by use of velocity control performance information allocation represented in FIG. 5 and angular velocity control performance information allocation represented in FIG. 6.

The status estimation unit 104 first derives, from the above-described first information group, a velocity error, velocity response, an angular velocity error, and angular velocity response that are required.

The status estimation unit 104 specifies, from the derived velocity error and velocity response, a velocity control performance information ID by the velocity control performance information allocation represented in FIG. 5.

The status estimation unit 104 also specifies, from the derived angular velocity error and angular velocity response, angular velocity control performance information ID by the angular velocity control performance information allocation represented in FIG. 6.

The status estimation unit 104 previously holds, in a non-illustrated storage unit, seventh association information representing association of a velocity/angular velocity control system included in the second control unit 152 with a combination of a velocity control performance information ID and an angular velocity control performance information ID that are related to the velocity/angular velocity control system.

The status estimation unit 104 selects, with reference to the seventh association information, one velocity/angular velocity control system being higher in velocity control performance than the specified velocity control performance information ID and higher in angular velocity control performance than the specified angular velocity control performance information ID. When there are a plurality of velocity control information units satisfying the above-mentioned performance, the status estimation unit 104 may select, from among the velocity control information units, a unit that performs control with the least power consumption. A unit that performs control with the least power consumption may be a unit with the lowest performance in which velocity control performance is combined with angular velocity control performance.

### Specific Example

Next, a specific example of a flying operation of the flying body 501 represented in FIG. 1 is described.

As a premise of a flight described below, it is assumed that the flying body 501 includes at least a camera, a plurality of laser distance meters, and a wind velocity meter as sensors of the sensor group 301. Sensor information acquired by the sensors is surrounding state information representing a state of a surrounding of the flying body 501 as described above.

It is assumed that the flying body 501 includes, as the work unit 451, a configuration that performs a hammering test for a designated place of a bridge pier.

It is assumed that the flying body 501 performs a flight of taking off from a point A, performing a hammering test for a designated place of a desired bridge pier, and landing on the point A. It is assumed that no particular obstacle to a flight exists between the point A and the bridge pier group.

The flying body 501 first takes off at the point A, and ascends to a predetermined height above the point A.

In this instance, it is assumed that the wind velocity sensor sends sensor information representing a slight wind to the mode designation unit 101. The sensor information is the above-described surrounding state information representing a state being strength of a wind in a surrounding of the flying body 501. In the following description, it is assumed that, when the flying body 501 performs an observation or the like of a slight wind or a strong wind, the wind velocity sensor sends, to the mode designation unit 101, the surrounding state information representing strength or weakness of the wind.

The mode designation unit 101 sends, to a status estimation unit, the above-described flight mode information S09 representing an ascending mode during a slight wind.

The status estimation unit 104 derives position/orientation divergence information representing a degree of divergence between the position/orientation target information S10 and the position/orientation estimation information S07 at this time point.

It is assumed that position/orientation control is associated with an ascending mode during a slight wind in the above-described first association information held by the status estimation unit 104.

It is assumed that, in the above-described second association information, ep is associated as a position control performance information ID, and ea is associated as an orientation control performance information ID, with a case where the mode is the ascending mode and position/orientation divergence information is the derived information.

In this case, the status estimation unit 104 sends, to the selection unit 105, the control mode determination information S14 representing that position/orientation control is performed. The status estimation unit 104 also specifies, from a position control performance information ID of ep and an orientation control performance information ID of ea, a position/orientation control system of the first control unit 151 satisfying control performance represented by the IDs, by the sixth association information. The status estimation unit 104 sends, to the first control unit 151, the first selection information S12 including the specified ID of the position/orientation control system.

The first control unit 151 specifies a position/orientation control system that performs position/orientation control by the first selection information S12. The position/orientation control system generates the position/orientation control information S16, by the position/orientation estimation information S07 sent from a drive control unit, and the position/orientation target information S10 included in the first selection information S12, and sends the position/orientation control information S16 to the selection unit 105.

The selection unit 105 selects, by the S14 sent from the status estimation unit 104, the position/orientation control information S16 sent from the first control unit 151. The selection unit 105 sends the control information S15 including the position/orientation control information S16 to the drive control unit 206.

The drive control unit 206 drives the flight enablement unit 401 in accordance with the position/orientation control information S16 included in the control information S15.

The flight enablement unit 401 floats the flying body 501 to a predetermined height while maintaining an orientation thereof approximately level, in accordance with the position/orientation control information S16.

The mode designation unit 101 determines that the flying body 501 floats to the predetermined height, by the position/orientation estimation information S07 sent from the drive control unit 206. The flying body 501 performs the determination that the predetermined height is reached, by the position/orientation estimation information S07 represented in FIG. 2. The position/orientation estimation information S07 is movement state information representing a movement state of the flying body 501.

In this instance, it is assumed that the wind velocity meter observes a slight wind. In this case, the mode designation unit 101 switches a flight mode to the flight mode being a level flight mode during a slight wind.

The mode designation unit 101 sends the flight mode information S09 representing a level flight mode during a slight wind to a status estimation unit.

The mode designation unit 101 derives velocity/angular velocity error information representing an error between the velocity/angular velocity target information S11 and the velocity/angular velocity estimation information S08 at this time point.

It is assumed that, in the above-described first association information held by the status estimation unit 104, velocity/angular velocity control is associated with a level flight mode during a slight wind. The association is performed, for example, for a reason that it is desired to fly the flying body 501 at the highest velocity.

On the other hand, it is assumed that, in the above-described fourth association information, av is associated as a velocity control performance information ID, and cr is associated as an angular velocity control performance information ID, with a case where the mode is the level flight mode during a slight wind and velocity/angular velocity divergence information is the derived information.

In this case, the status estimation unit 104 sends, to the selection unit 105, the control mode determination information S14 representing that velocity/angular velocity control is performed. The status estimation unit 104 also specifies, from a velocity control performance information ID of av and an angular velocity control performance information ID of cr, a velocity/angular velocity control system of the second control unit 152 satisfying control performance represented by the IDs, by the seventh association information. The status estimation unit 104 sends, to the second control unit 152, the second selection information S13 including the specified ID of the velocity/angular velocity control system.

The second control unit 152 specifies a velocity/angular velocity control system that performs velocity/angular velocity control by the second selection information S13. The velocity/angular velocity control system generates the velocity/angular velocity control information S17, by the velocity/angular velocity estimation information S08 sent from a drive control unit, and the velocity/angular velocity target information S11 included in the second selection information S13, and sends the velocity/angular velocity control information S17 to the selection unit 105.

The selection unit 105 selects, by the S14 sent from the status estimation unit 104, the velocity/angular velocity control information S17 sent from the second control unit 152. The selection unit 105 sends the control information S15 including the velocity/angular velocity control information S17 to the drive control unit 206.

The drive control unit 206 drives the flight enablement unit 401 in accordance with the velocity/angular velocity control information S17 included in the control information S15.

The flight enablement unit 401 flies the flying body 501 in accordance with the velocity/angular velocity control information S17.

During a flight of the flying body 501, the above-described camera of the sensor group 301 captures an image in a traveling direction of the flying body 501, and sequentially acquires captured images.

The capture information is the above-described sensor information. Sensor information is surrounding state information representing a state of a surrounding, as described above.

The mode designation unit 101 determines whether a captured image sent from the camera includes an image pattern of the above-described bridge pier group. Herein, it is premised that the mode designation unit 101 includes an image recognition function. It is also premised that the mode designation unit 101 holds an image pattern of the bridge pier group in a non-illustrated storage unit.

When determining that an image pattern of the bridge pier group is included in a captured image, the mode designation unit 101 measures a size of an image pattern in a predetermined portion included in the bridge pier group in the captured image.

When the size of the image pattern in the portion exceeds a predetermined value, the mode designation unit 101 sends the flight mode information S09 to the status estimation unit 104. Herein, it is premised that the wind velocity meter measures a slight wind at this time point.

The mode designation unit 101 specifies a position of the flying body 501 by an excess of the size of the image pattern in the portion over the predetermined value. In other words, herein, the mode designation unit 101 uses the size of the image pattern in the portion as the movement state information representing a movement state of the flying body 501.

By being sent the flight mode information S09 representing a bridge pier group passage flight mode during a slight wind sent from the mode designation unit 101, the status estimation unit 104 sends, to the selection unit 105, the control mode determination information S14 that causes position/orientation control to be selected. Herein, flight control of the flying body 501 is switched from velocity/angular velocity control to position/orientation control because reliably avoiding collision with each bridge pier of the bridge pier group is assumed.

The status estimation unit 104 also derives the position/orientation divergence information.

The status estimation unit 104 also specifies, from the flight mode information S09 and the derived position/orientation divergence information, dp as a position control performance information ID, and da as an orientation control performance information ID, respectively. The status estimation unit 104 specifies an ID of a position/orientation control system included in the first control unit 151 satisfying position control performance and orientation control performance represented by the IDs. The status estimation unit 104 sends, to the first control unit 151, the first selection information S12 including an ID of a specified position/orientation control degree control unit. The first control unit 151 causes a position/orientation control system selected by the first selection information S12 to perform subsequent position/orientation control.

The selected position/orientation control system generates the position/orientation control information S16 from position/orientation target information included in the first selection information, and position/orientation estimation information sent from the drive control unit 206, and sends the position/orientation control information S16 to the selection unit 105.

The selection unit 105 selects the position/orientation control information S16 by the control mode determination information S14 sent from the status estimation unit 104. The selection unit 105 sends, to the drive control unit 206, the control information S15 including the position/orientation control information S16.

The drive control unit 206 drives the flight enablement unit 401 by the position/orientation control information S16 included in the control information S15, and flies, by position/orientation control, the flying body 501 safely in such a way that the flying body 501 does not contact each bridge pier of the bridge pier group.

During the flight, the mode designation unit 101 continues determination regarding whether a feature pattern representing a test place where a hammering test is scheduled to be performed appears in a captured image by the camera. When determining that the feature pattern appears in the captured image, the mode designation unit 101 measures a size of the feature pattern in the captured image.

When the size exceeds a predetermined value, the mode designation unit 101 sends, to the status estimation unit 104, the flight mode information S09 representing an approach mode during a slight wind. Herein, it is assumed that the wind velocity meter still observes a slight wind.

Herein, the mode designation unit 101 specifies a position of the flying body 501 from a size of the feature pattern. In other words, the mode designation unit 101 uses the size of the feature pattern as the movement state information. The mode designation unit 101 specifies the flight mode from the surrounding state information being a slight wind, and the movement state information that a size of the feature pattern is a predetermined value.

The status estimation unit 104 sends the control mode determination information S14 representing position/orientation control to the selection unit 105. Herein, it is assumed that position/orientation control is previously associated with an approach mode during a slight wind.

Next, the status estimation unit 104 derives the position/orientation error information. When the position/orientation error information is derived information in an approach mode during a slight wind, the status estimation unit 104 derives a position control performance information ID and an orientation control performance information ID by the fourth association information. It is assumed that the position control performance information ID in this instance is hp represented in FIG. 3, and the orientation control performance information ID is ha.

In this case, the status estimation unit 104 specifies, by the sixth association information, a position/orientation control system of which position control performance is equal to or more than performance represented by the position control performance information hp, and of which orientation control information is equal to or more than the orientation control performance information ha. The status estimation unit 104 sends the first selection information S12 including an ID of the specified position/orientation control system to the first control unit 151.

The selected position/orientation control system generates the position/orientation control information S16 from position/orientation target information included in the first selection information, and position/orientation estimation information sent from the drive control unit 206, and sends the position/orientation control information S16 to the selection unit 105.

The selection unit 105 selects the position/orientation control information S16 by the control mode determination information S14 sent from the status estimation unit 104. The selection unit 105 sends, to the drive control unit 206, the control information S15 including the position/orientation control information S16.

The drive control unit 206 drives the flight enablement unit 401 by the position/orientation control information S16 included in the control information S15, and moderately brings the flying body 501 into contact with a hammering measurement subject by position/orientation control.

The mode designation unit 101 determines that the flying body 501 contacts a hammering measurement subject, by sensor information from a second laser distance meter that measures a distance to an object in front of the flying body 501.

Accordingly, the mode designation unit 101 sends the flight mode information S09 representing a measurement mode to the status estimation unit 104.

The status estimation unit 104 selects velocity/angular velocity control by the flight mode information S09. The status estimation unit 104 sends, to the selection unit 105, the control mode determination information S14 that causes velocity/angular velocity control to be selected. Performing velocity/angular velocity control when the flight mode information S09 is a measurement mode is previously determined for the following reason.

Specifically, when a hammering measurement by a measurement mode is performed, the flying body 501 brings, for example, a tip of a hammering test machine into contact with an inspection subject such as a wall surface of a bridge pier or the like, in a way similar to the flying robot described in the section of Technical Problem. The flying body 501 generates a sound by driving a hammer mounted on the hammering test machine at a certain frequency, and continuously beating the side surface with the hammer. Further, the flying body 501 performs a hammering test for a predetermined range of the inspection subject by moving the tip at a predetermined velocity. Thus, it is important that a velocity at which the tip portion moves is as set. Herein, a velocity at which the tip portion moves depends on a velocity and an angular velocity of the flying body 501. This is why controlling a velocity and an angular velocity of the flying body 501 is needed.

The status estimation unit 104 also specifies, from the flight mode information S09, and a degree of divergence between the velocity/angular velocity target information S11 and the velocity/angular velocity estimation information S08, a velocity control performance information ID and an angular velocity control performance information ID that are previously associated with a combination of the pieces of information. It is assumed that the velocity control performance information ID in this instance is hv represented in FIG. 5, and the angular velocity control performance information ID is hr represented in FIG. 6.

In this case, the status estimation unit 104 specifies a velocity/angular velocity control system of which velocity control performance is performance represented by the velocity control performance information hv, and of which angular velocity control information is the angular velocity control performance information hr. The status estimation unit 104 sends the second selection information S13 including an ID of the specified velocity/angular velocity control system to the second control unit 152.

The selected velocity/angular velocity control system generates the velocity/angular velocity control information S17 from the velocity/angular velocity target information S11 included in the second selection information S13, and the velocity/angular velocity estimation information S08 sent from the drive control unit 206, and sends the velocity/angular velocity control information S17 to the selection unit 105.

The selection unit 105 selects the velocity/angular velocity control information S17 by the control mode determination information S14 sent from the status estimation unit 104. The selection unit 105 sends, to the drive control unit 206, the control information S15 including the velocity/angular velocity control information S17.

The drive control unit 206 drives the flight enablement unit 401 by the velocity/angular velocity control information S17 included in the control information S15, and causes the hammering portion of the flying body 501 to beat a hammering measurement subject. The work control unit 256 and the work unit 451 perform a hammering measurement of the hammering measurement subject.

When a flight in a previously determined measurement mode is completed, the flying body 501 performs a return flight toward the point A. First, the flying body 501 flies between bridge piers of the bridge pier group.

It is assumed that the wind velocity meter initially observes a slight wind, but observes a strong wind during a flight between bridge piers of the bridge pier group.

In this case, the mode designation unit 101 switches the flight mode information S09 to be sent to the status estimation unit 104, from the initial bridge pier group passage flight mode during a slight wind to a bridge pier group passage mode during a strong wind. Herein, the mode designation unit 101 switches a flight mode by surrounding state information being a wind velocity.

Thus, the status estimation unit 104 increases position control performance and orientation control performance in a position/orientation control system to be selected by the first control unit 151, while maintaining position/orientation control in S14. When the flying body 501 is hit by a strong wind, the increase is performed in order to increase a response velocity at which a position/orientation of the flying body 501 is brought closer to a position/orientation target.

When determining that an estimated position of the flying body 501 is a predetermined distance away from the bridge pier group, the mode designation unit 101 switches a flight mode to a level flight mode. The mode designation unit 101 performs, by the position/orientation estimation information S07 being the movement state information, determination that the flying body 501 is the predetermined distance away from the bridge pier group.

As a result, the velocity/angular velocity control system of the second control unit 152 selected as mentioned above performs velocity/angular velocity control over the drive control unit 206.

When determining that an estimated position of the flying body 501 is close to the point A, the mode designation unit 101 switches a flight mode to a landing mode. In this instance, the mode designation unit 101 performs, by the position/orientation estimation information S07 being the movement state information, determination that the flying body 501 is close to the point A.

The position/orientation control system of the first control unit 151 selected as mentioned above causes, by position/orientation control, the flying body 501 to land on the point A.

### Advantageous Effect

A flying body according to the present example embodiment selects, by sensor information representing a state of a surrounding of the flying body and movement state information representing a movement state, whether to perform control of a position and an orientation of the flying body (position/orientation control) or control of a velocity and an angular velocity of the flying body (velocity/angular velocity control).

Thus, the flying body is capable of performing flight control (positioning control and movement control) being more suitable to a state of a surrounding and a state of movement.

When further performing position/orientation control, the flying body selects performance (accuracy) of position/orientation control by the sensor information and the movement state information. When performing velocity/angular velocity control, the flying body selects performance (accuracy) of velocity/angular velocity control by the sensor information and the movement state information.

Thus, the flying body is capable of performing flight control (positioning control and movement control) being further suitable to a state of a surrounding and a state of movement.

Although it is premised in the above description that each sensor of a sensor group is mounted on a flying body, some sensors may be placed outside the flying body and measure a state of the flying body. In this case, a movement control unit includes a function of receiving information sent by radio or the like from a sensor placed outside.

Although it is premised in the above description that a movement control unit is included in a flying body, some or all of movement control units may be placed outside the flying body. In this case, it is assumed that each of the outside components can communicate with each relevant component placed on the flying body by radio or the like.

Although an example regarding a case where a moving body is a flying body is described above, a moving body according to an example embodiment is not limited to an air movement device such as a flying body. The moving body may be a ground movement device, an underground movement device, an object-surface movement device, an object-interior movement device, an on-liquid movement device, an in-liquid movement device, a space movement device, or the like.

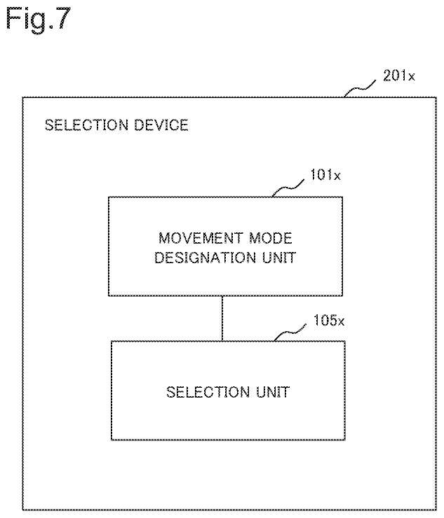

FIG. 7 is a block diagram representing a configuration of a selection device 201x being a minimum configuration of a selection device according to an example embodiment.

The selection device 201x includes a movement mode designation unit 101x and a selection unit 105x.

The movement mode designation unit 101x designates, from surrounding state information representing a state of a surrounding of a moving body performing movement, and movement state information representing a movement state of the moving body, a movement mode related to the movement.

The selection unit 105x performs, depending on the movement mode, control mode selection being selection of one of a first control mode for performing first control being control of a position and an orientation of the moving body, and a second control mode for performing second control being control of a velocity and an angular velocity of the moving body.

Depending on a movement state of a flying body and a state of a surrounding, a case where control of a position and an orientation is preferably performed and a case where control of a velocity and an angular velocity is preferably performed are assumable regarding the movement.

Depending on a state of a surrounding of a moving body and a movement state, the selection device 201x switches a control mode related to the movement between the first control mode for performing control of a position and an orientation of the moving body, and the second control mode for controlling a velocity and an angular velocity of the moving body.

This enables movement control (positioning control and movement control) of a moving body being more suitable to a movement state of the moving body and a state of a surrounding.

Thus, the selection unit 105x brings about the advantageous effect described in the section [Advantageous Effects of Invention] by the configuration.

The selection device 201x represented in FIG. 7 is, for example, a combination of the determination unit 150 and the selection unit 105 represented in FIG. 2. The movement mode designation unit 101x is, for example, the mode designation unit 101 represented in FIG. 2. The selection unit 105x is, for example, a combination of the status estimation unit 104 and the selection unit 105 represented in FIG. 2. The moving body is, for example, the flying body 501 represented in FIG. 1. The movement state information is, for example, the above-described position/orientation estimation information, or image information representing a position of the moving body among the above-described pieces of sensor information. The movement mode is, for example, the above-described flight mode. The first control mode is, for example, the above-described position/orientation control mode. The second control mode is, for example, the above-described velocity/angular velocity control information.

While each example embodiment of the present invention has been described above, the present invention is not limited to the example embodiment described above, and a further modification, replacement, and adjustment can be made without departing from the basic technical concept of the present invention. For example, a configuration of an element illustrated in each drawing is one example for helping understand the present invention, and is not limited to the configuration illustrated in the drawings.

The whole or part of the example embodiments disclosed above can be described as, but not limited to, the following supplementary notes.

### (Supplementary Note 1)

A selection device including:

a movement mode designation unit that designates, from surrounding state information representing a state of a surrounding of a moving body performing movement, and movement state information representing a movement state of the moving body, a movement mode related to the movement; and

a selection unit that performs, depending on the movement mode, control mode selection being selection of one of a first control mode for performing first control being control of a position and an orientation of the moving body, and a second control mode for performing second control being control of a velocity and an angular velocity of the moving body.

### (Supplementary Note 2)

The selection device according to Supplementary Note 1, wherein the surrounding state information is sent from a sensor that acquires a state of the surrounding.

### (Supplementary Note 3)

The selection device according to Supplementary Note 1 or 2, wherein the surrounding state information includes information representing a wind velocity or a direction related to a wind blowing against the moving body.

### (Supplementary Note 4)

The selection device according to any one of Supplementary Notes 1 to 3, wherein the surrounding state information includes image information captured by the moving body.

### (Supplementary Note 5)

The selection device according to any one of Supplementary Notes 1 to 4, wherein the surrounding state information includes information representing a distance between the moving body and a thing existing in the surrounding.

### (Supplementary Note 6)

The selection device according to any one of Supplementary Notes 1 to 5, wherein the surrounding state information includes information representing a state of contact between the moving body and a thing existing in the surrounding.

### (Supplementary Note 7)

The selection device according to any one of Supplementary Notes 1 to 6, wherein the movement mode designation unit may employ, as the movement state information, position estimation information representing an estimated value of the position.

### (Supplementary Note 8)

The selection device according to any one of Supplementary Notes 1 to 6, wherein the movement mode designation unit may employ, as the movement state information, position estimation information representing an estimated value of the position, and position/orientation divergence information representing a degree of divergence between the position estimation information and position target information representing a target value of the position.

### (Supplementary Note 9)

The selection device according to any one of Supplementary Notes 1 to 8, wherein the movement mode designation unit may employ, as the movement state information, information representing a size of a predetermined thing in an image captured by a capture device included in the moving body.

### (Supplementary Note 10)

The selection device according to any one of Supplementary Notes 1 to 9, wherein the selection unit performs first selection being selection of performance of the first control.

### (Supplementary Note 11)

The selection device according to Supplementary Note 10, wherein performance of the first control is dependent on a combination of an error related to position control of the moving body and a response time, and a combination of an error related to orientation control of the moving body and a response time.

### (Supplementary Note 12)

The selection device according to Supplementary Note 10 or 11, wherein the selection unit performs the first selection by specifying, from among a first plurality of position/orientation control systems differing in performance related to the first control, a position/orientation control system that is caused to perform the first control.

### (Supplementary Note 13)

The selection device according to Supplementary Note 12, further including a position/orientation control unit being capable of selecting the first plurality of the position/orientation control systems.

### (Supplementary Note 14)

The selection device according to any one of Supplementary Notes 10 to 13, wherein the selection unit performs the first selection by the movement mode during the first selection.

### (Supplementary Note 15)

The selection device according to any one of Supplementary Notes 10 to 13, wherein the selection unit performs the first selection by the movement mode during the first selection, and position/orientation error information representing a degree of an error, during the first selection, between position/orientation estimation information representing estimated values of the position and the orientation, and position/orientation target information representing target values of the position and the orientation.

### (Supplementary Note 16)

The selection device according to any one of Supplementary Notes 1 to 15, wherein the selection unit performs second selection being selection of performance of the second control.

### (Supplementary Note 17)

The selection device according to Supplementary Note 16, wherein performance of the second control is dependent on a combination of an error related to velocity control of the moving body and a response time, and a combination of an error related to angular velocity control of the moving body and a response time.

### (Supplementary Note 18)

The selection device according to Supplementary Note 16 or 17, wherein the selection unit performs the second selection by selecting, from among a second plurality of velocity/angular velocity control systems differing in performance related to the second control, a velocity/angular velocity control system that is caused to perform the second control.

### (Supplementary Note 19)

The selection device according to Supplementary Note 18, further including a velocity/angular velocity control unit being capable of selecting the second plurality of the velocity/angular velocity control systems.

### (Supplementary Note 20)

The selection device according to any one of Supplementary Notes 16 to 18, wherein the selection unit performs the second selection by the movement mode during the second selection.

### (Supplementary Note 21)

The selection device according to any one of Supplementary Notes 16 to 20, wherein the selection unit performs the second selection by specifying a combination of velocity control performance being performance related to velocity control and angular velocity control performance being performance related to angular velocity control, the combination being associated with the movement mode during the second selection.

### (Supplementary Note 22)

The selection device according to any one of Supplementary Notes 1 to 21, wherein the movement is air movement.

### (Supplementary Note 23)

A control device including:

the selection device according to any one of Supplementary Notes 1 to 22;

a first control unit that performs the first control; and

a second control unit that performs the second control.

### (Supplementary Note 24)

A moving device being the moving body, including:

the control device according to Supplementary Note 23; and

a movement enablement unit being controlled by the control device and enabling the movement.

### (Supplementary Note 25)

The moving device according to Supplementary Note 24, further including a sensor that acquires the surrounding state information.

### (Supplementary Note 26)

The moving device according to Supplementary Note 24 or 25, being a multicopter or a drone.

### (Supplementary Note 27)

A work device including:

the moving device according to any one of Supplementary Notes 24 to 26; and

a work unit that performs set work when the movement mode is predetermined.

### (Supplementary Note 28)

The work device according to Supplementary Note 27, wherein the work is a test of a subject.

### (Supplementary Note 29)

The work device according to Supplementary Note 28, wherein the test is a hammering test that examines a state of a sound by beating the subject.

### (Supplementary Note 30)

A selection method including:

designating, from surrounding state information representing a state of a surrounding of a moving body performing movement, and movement state information representing a movement state of the moving body, a movement mode related to the movement; and

performing, depending on the movement mode, control mode selection being selection of one of a first control mode for performing first control being control of a position and an orientation of the moving body, and a second control mode for performing second control being control of a velocity and an angular velocity of the moving body.

### (Supplementary Note 31)

A recording medium recording a selection program causing a computer to execute:

processing of designating, from surrounding state information representing a state of a surrounding of a moving body performing movement, and movement state information representing a movement state of the moving body, a movement mode related to the movement; and

processing of performing, depending on the movement mode, control mode selection being selection of one of a first control mode for performing first control being control of a position and an orientation of the moving body, and a second control mode for performing second control being control of a velocity and an angular velocity of the moving body.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2018-155678, filed on Aug. 22, 2018, the disclosure of which is incorporated herein in its entirety by reference.

### REFERENCE SIGNS LIST

101 Mode designation unit

102 Position/orientation target generation unit

103 Velocity/angular velocity target generation unit

104 Status estimation unit

150 Determination unit

151 First control unit

152 Second control unit

201 Movement control unit

206 Drive control unit

256 Work control unit

301 Sensor group

401 Flight enablement unit

451 Work unit

501 Flying body

S1, S2, Sn Sensor

SS1, SS2, SSn Sensor information

S09 Flight mode information

S10 Position/orientation target information

S11 Velocity/angular velocity target information

S12 First selection information

S13 Second selection information

S14 Control mode determination information

S15 Control information

S16 Position/orientation control information

S17 Velocity/angular velocity control information

p1, p2, pn Position/orientation control system

v1, v2, vn Velocity/angular velocity control system

ap, bp, cp, dp, ep, fp, gp, hp Position control performance information

aa, ba, ca, da, ea, fa, ga, ha Orientation control performance information

av, by, cv, dv, ev, fv, gv, hv Velocity control performance information

ar, br, cr, dr, er, fr, gr, hr Angular velocity control performance information

What is claimed is:

1. A selection device comprising:
a movement mode designation unit configured to designate, from surrounding state information representing a state of a surrounding of a moving body performing movement, and movement state information representing a movement state of the moving body, a movement mode related to the movement; and
a selection unit configured to perform, depending on the movement mode, control mode selection being selection of one of a first control mode for performing first control being control of a position and an orientation of the moving body, and a second control mode for performing second control being control of a velocity and an angular velocity of the moving body.

2. The selection device according to claim 1, wherein the surrounding state information is sent from a sensor that acquires a state of the surrounding.

3. The selection device according to claim 1, wherein the surrounding state information includes information representing a wind velocity or a direction related to a wind blowing against the moving body.

4. The selection device according to claim 1, wherein the surrounding state information includes image information captured by the moving body.

5. The selection device according to claim 1, wherein the surrounding state information includes information representing a distance between the moving body and a thing existing in the surrounding.

6. The selection device according to claim 1, wherein the surrounding state information includes information representing a state of contact between the moving body and a thing existing in the surrounding.

7. The selection device according to claim 1, wherein the movement mode designation unit may employ, as the movement state information, position estimation information representing an estimated value of the position.

8. The selection device according to claim 1, wherein the movement mode designation unit may employ, as the movement state information, position estimation information representing an estimated value of the position, and position/orientation divergence information representing a degree of divergence between the position estimation information and position target information representing a target value of the position.

The selection device according to claim 1, wherein the movement mode designation unit may employ, as the movement state information, information representing a size of a predetermined thing in an image captured by a capture device included in the moving body.

10. The selection device according to claim 1, wherein the selection unit performs first selection being selection of performance of the first control.

11. The selection device according to claim 10, wherein performance of the first control is dependent on a combination of an error related to position control of the moving body and a response time, and a combination of an error related to orientation control of the moving body and a response time.

12. The selection device according to claim 10, wherein the selection unit performs the first selection by specifying, from among a first plurality of position/orientation control systems differing in performance related to the first control, a position/orientation control system that is caused to perform the first control.

13. The selection device according to claim 12, further comprising a position/orientation control unit being capable of selecting the first plurality of the position/orientation control systems.

14. The selection device according to claim 10, wherein the selection unit performs the first selection by the movement mode during the first selection.

15. The selection device according to claim 10, wherein selection unit performs the first selection by the movement mode during the first selection, and position/orientation error information representing a degree of an error, during the first selection, between position/orientation estimation information representing estimated values of the position and the orientation, and position/orientation target information representing target values of the position and the orientation.

16. The selection device according to claim 1, wherein the selection unit performs second selection being selection of performance of the second control.

17. The selection device according to claim 16, wherein performance of the second control is dependent on a combination of an error related to velocity control of the moving body and a response time, and a combination of an error related to angular velocity control of the moving body and a response time.

18. The selection device according to claim 16, wherein the selection unit performs the second selection by selecting, from among a second plurality of velocity/angular velocity control systems differing in performance related to the second control, a velocity/angular velocity control system that is caused to perform the second control.

19.-29. (canceled)

30. A selection method comprising:
designating, from surrounding state information representing a state of a surrounding of a moving body performing movement, and movement state information representing a movement state of the moving body, a movement mode related to the movement; and
performing, depending on the movement mode, control mode selection being selection of one of a first control mode for performing first control being control of a position and an orientation of the moving body, and a second control mode for performing second control being control of a velocity and an angular velocity of the moving body.

31. A non-transitory computer readable recording medium recording a selection program causing a computer to execute:
processing of designating, from surrounding state information representing a state of a surrounding of a moving body performing movement, and movement state information representing a movement state of the moving body, a movement mode related to the movement; and
processing of performing, depending on the movement mode, control mode selection being selection of one of a first control mode for performing first control being control of a position and an orientation of the moving body, and a second control mode for performing second control being control of a velocity and an angular velocity of the moving body.
